(19) United States
(12) Patent Application Publication
(10) Pub. No.: US 2004/0057578 A1
(43) Pub. Date: Mar. 25, 2004

(54) Wearable phone and wristwatch having a detachable phone module and a separate phone carriage

(76) Inventor: Donald R. Brewer, Richardson, TX (US)

Correspondence Address: CARSTENS YEE & CAHOON, LLP, P O BOX 802334, DALLAS, TX, 75380

(21) Appl. No.: 10/613,713

(22) Filed: Jul. 3, 2003

Related U.S. Application Data
(60) Provisional application No. 60/394,584, filed on Jul. 9, 2002.

(51) Int. Cl. H04M 1/00; H04M 9/00

(52) U.S. Cl. 379/433.1

(57) ABSTRACT

The present invention relates to a phone module contained within a wristphone unit that can be inserted into a supporting watchband style carriage, or removed and inserted in a conventional cell phone style carriage. Other features can include speaker and microphone components in both the watch carriage and the cell phone carriage, allowing smaller components to be used in the wrist-worn configuration. Other features may be separated from the core phone module such as a numeric keypad.

### 1. CROSS-REFERENCE TO RELATED APPLICATION

This application claims the benefit of and priority to a U.S. Provisional Patent Application No. 60/394,584 filed Jul. 9, 2002, the technical disclosure of which is hereby incorporated herein by reference.

### BACKGROUND OF THE INVENTION

2. Technical Field

The present invention relates to a wearable phone and wristwatch wherein the wearable phone can be connected to a separate phone carriage that provides additional functionality. The wearable phone includes a phone module with basic functionality.

3. Background to the Invention

Wristwatches are popular for both aesthetic and functional purposes. It is not uncommon for an individual to wear a wristwatch and also to carry a cellular phone. Yet, in many circumstances, a cellular phone is unwieldy. For example, when exercising, a user may find it cumbersome to carry a cell phone. A variety of proposals have previously been made to improve the portability of cell phones. One solution has been to make cell phones particularly small. FIG. 1a is a popular cell phone that is small enough to place into a shirt pocket. The phone 10 has a numeric keypad 12, a SEND 14 and END 15 keys, a display 16 and a speaker 18. A user enters the phone number to be called with the keypad 12, and presses the SEND 14 button. The user listens with the speaker 18 and presses END 15 to finish the call. Of course, the user must hold the phone 10 during the call or to view information on the display 16.

Others have attempted to converge the functionality of a cell phone with a personal digital assistant (PDA). For example, the VisorPhone™ by Handspring™ is a hand held computer, or personal data assistant that has a plug-in unit that simulates cell phone capability. The plug in unit is a dual band world phone and a wireless modem, allowing cell phone functionality and wireless Internet access. Software running on the VisorPhone™ controls the phone/internet use. The device also allows short text messages. The device generally combines a PDA with a cell phone module, which plugs into a top port of the PDA. Of course, the user again must hold the VisorPhone™. The PDA also has a clock function that displays the time.

A number of prior proposals have sought to combine or incorporate a cell phone into a wristwatch device. For example, U.S. Pat. No. 6,035,035 to Firooz, entitled “Wrist Mounted Telephone Device,” discloses an oval shaped wearable phone that fits around a user's wrist. FIG. 1b shows one embodiment of the Firooz '035 wearable phone 20. To use the phone 20, a speaker element 22 telescopes outward from the phone. The user then turns her wrist 24 so that the speaker 22 is near her ear. The phone 20 is hinged 26 and can be opened and removed from the user's wrist. In either case, the Firooz '035 phone is ungainly in its operation. While a watch unit can be mounted on the opposite side of the oval shaped frame, by placing the phone controls and the watch on opposite sides of the oval shaped band, the user is inconvenienced when wanting to view the time.

U.S. Pat. No. 6,192,253 to Charlier et al., entitled “Wrist-Carried Radiotelephone,” also discloses a wristwatch having a cell phone incorporated therein. As shown in FIG. 1c, the Charlier et al. '253 watch 30 has a first housing 32 that includes a microphone 34, a display 33 and a circuitry of a radio transceiver. The display 33 is adapted to show the time and date. A second housing 36 includes a latch 35 and a speaker 38. In use, when a user receives a call, he uncouples the latch 35 and straightens the strap. He can then hold the speaker 38 near his ear and the microphone 34 near his mouth. The user is limited to the functionality that can be placed on either the first or second housings 32, 36. Also, in use, the entire Charlier et al. '253 device must be removed from the user's wrist.

U.S. Pat. No. 5,274,613 to Saeger, entitled “Wristwatch Radiotelephone,” discloses a combined wristwatch and radiotelephone, which is suitable in one configuration for wearing on the wrist as a wristwatch, and in another configuration for use as a hand-held radiotelephone. As shown in FIGS. 1d and 1e, the wristwatch radiotelephone of the Saeger '613 patent includes an annular wristband portion 50 and a timekeeping and radiotelephone portion 40 removably mounted on one side of the wristband portion. The wristband portion 50 includes an arrowhead snap 56 on one side for removably securing timekeeping and radiotelephone portion 40 to the wristband. The arrowhead snap 56 fits into a mating recess (not shown) in the underside of portion 40. This structure holds portion 40 securely to portion 50 but allows the user to pull portion 40 off portion 50 whenever desired. However, when it is desired to use the Saeger '613 apparatus as a radiotelephone, portion 40 must be removed from wristband portion 50 by pulling portion 40 off arrowhead snap 56. The user then pivots each of end members 42 and 46 out from member 45 approximately 180° as shown. Thus, the Saeger '613 device only allows portion 40 to be attached in one configuration to wristband portion 50. Moreover the Saeger '613 device does not allow a user to answer or make telephone calls with the radiotelephone portion 40 connected to the wristband portion 50. While perhaps improving the portability of the incorporated radiotelephone, the Saeger '613 device still requires that the radiotelephone be operated in a conventional hand-held manner.

Prior proposals also include U.S. Pat. No. 5,008,864 to Yoshitake, entitled “Portable Radio Telephone Device.” As shown in FIG. 1f, the Yoshitake '864 patent discloses a portable radiotelephone device 60 in which a radio device body 62 is mounted in the form of a wristwatch on an arm by means of a carrying strap 64. The Yoshitake '864 patent highlights a problem inherent in incorporating radiotelephone technology into a wrist worn devices. As instrumentation is miniaturized and adapted for incorporation into a wrist worn device, the antenna comprises a more significant portion of the device. According to the Yoshitake '864 patent, it is extremely difficult to incorporate an antenna into the main body 62 in view of the required antenna efficiency, the mixing-up of receiving and transmission, miniaturization, productivity and the like. To overcome this problem, the Yoshitake '864 device discloses the incorporation of an antenna 66 embedded into the wristband carrying strap 64. Similarly, a voice transmission tube 68 is also incorporated into the wristband carrying strap 64 to separate, both acoustically and electrically, the sending speech function from the receiving function. However, the radio device body 62 the Yoshitake '864 device, while detachable from the wristband carrying strap 64, is not operable when detached.

Another prior proposal is U.S. Pat. No. 6,212,414 to Alameh et al., entitled “Wrist-Carried Radiotelephone,” which discloses a wrist-carried radiotelephone, which is operable without removing from a user's wrist. As shown in FIGS. 1g and 1h, wrist-carried radiotelephone 70 includes a housing 72 having a display and a battery 73, and a wristband 76 having a plurality of rigid and flexing portions. A plurality of segmented printed circuit boards 74 are disposed within a hollow portion of a curved section of a wristband 76. The printed circuit (PC) boards 74 of the Alameh et al. '414 device carry radiotelephone circuitry excluding the antenna and user interface circuits such as a display, and a battery 73. The PC boards 74 of the Alameh et al. '414 device can be rigid or flexible, and can be straight or curved. Preferably, the PC boards 74 are semi-flexible, and are substantially straight segments, as manufactured. The PC boards 74 are interconnected with wires to provide complete radiotelephone operation. Preferably, the wire interconnects are flex circuits as are known in the art. Moreover, the Alameh et al. '414 discloses no less than six antenna configurations usable in accordance with the invention. While the delineated configurations can be stationary, or movable to provide increased efficiency, all are embedded or incorporated to some degree into the wristband 76 of the invention. The housing 72 of the Alameh et al. '414 device also discloses a hinged display 72a which facilitates the removal of at least one battery 73 while the user is wearing the wristband 76. According to the Alameh et al. '414 patent, “convenient battery changing is important in wrist-worn cell phone devices as the batteries are much smaller than those available in standard cellular phones, and will need to be changed more often, even with the advent of exotic material technologies providing more powerful batteries, such as a lithium cell, for example. It is expected that a battery-housing configuration as described above can provide enough capacity (using a 23×23×6 mm Li-Polymer cell, for example) to power the radiotelephone circuitry for about one hour of conversation during a telephone call and for about twenty hours in a standby mode waiting to receive a call.”

While an ever-evolving diversity of digital wireless cell phone technology is available for adaptation into wrist-worn devices, adapting conventional cell phone and battery technology into devices suitable for use as wrist-worn devices inherently creates additional problems. Two of the most promising technologies currently available are Global System for Mobile Communications (GSM) and Code Division Multiple Access (CDMA). GSM is a digital cellular system found in almost all of Europe, parts of Asia, and parts of North America. Although designed as a European standard, due to its flexibility and excellent implementation of Time Division Multiple Access (TDMA) technology, GSM has grown into a truly worldwide standard. GSM uses General Packet Radio System (GPRS) technology to accommodate high-bandwidth data traffic. GPRS will handle rates from 14.4 Kbps using just one TDMA slot, and up to 115 Kbps and higher using all eight slots. It will also permit users to receive voice calls simultaneously when sending and receiving data. GSM also allows mobile terminals with different maximum output powers. The maximum power of the mobile determines its power class. Most of the mobiles are either 2W class 4 (900 MHz) or 1W class 1 for the 1900/1800 MHz operation.

Code Division Multiple Access (CDMA) is a digital cellular system used mainly in the United States and South Korea. CDMA is a spread spectrum modulation technology whereby channels defined by means of mathematical codes are able to share the same frequency band simultaneously (IS95 A/B, IS2000 1X-3X). Originally developed by Qualcomm®, CDMA uses more advanced encoding and spread spectrum technology to produce higher voice clarity and spectral efficiency than GSM. Additionally, CDMA handsets generally use low amounts of power. Recently, CDMA (IS-95) in the US has been upgraded to IS2000-1XRTT (1^{st} Generation Radio Transmit Technology of 3G) which can accommodate data rates as high as 144 Kbps. The 3× version will purportedly accommodate up to 1 Mbps. At the moment, CDMA technology networks are positioned with a much clearer and efficient path to 3G systems than GSM. In the United States, CDMA technology is the dominant player whereas GSM technology is the dominant player for the rest of the world.

With reference to FIG. 1i, a block diagram of the typical components of a conventional digital mobile phone is shown. The typical digital mobile phone may be conceptualized as three fundamental components: a transmission component, a reception component, and an auxiliary component. As depicted in FIG. 1i, the transmission component includes a microphone 80, connected to audio processing technology, which is further connected to channel encoding, interleaving and message generation functionality 82, which in turn connects to a ciphering means 83 and RF processing 84 prior to being transmitted via antenna 85. The reception component includes the same antenna 85 where a received message is in turn processed via RF processing 94 and de-ciphering means 83, which conveys the received message to a channel de-encoding, de-interleaving, and message regeneration functionality 92, whereupon it proceeds through audio processing 91 to produce a sound in speaker 90. The auxiliary component 96 includes a keypad, display, battery and other assorted auxiliary functionality.

Mobile phone units utilizing GSM technology further include a Subscriber Identity Module (SIM) 86 that stores a subscriber's unique identification information. The SIM 86 is typically a removable part of the mobile phone unit, thus, allowing the subscriber to access the network regardless of the particular mobile phone unit being used. The billing information is recorded on the card and when the user comes back to their home network, all billing information is uploaded. Development of the SIM 86 was driven by the early deployment of GSM networks since it provides roaming capability, even between the networks that are not connected through physical signaling lines. This kind of roaming, known as “SIM roaming,” allows roaming services between providers with disjoint wireless networks.

Regardless of the technology format used, it is difficult to add the important functionality of a cell phone to a wrist-worn device while not impairing the usefulness and ergonomics of the watch. Adapting conventional cell phone and battery technology into devices suitable for use as wrist-worn devices create additional problems. A need, therefore, exists for a more flexible unit that provides reasonable battery life to the phone and watch. Further, a need exists for an improved wrist-worn phone that allows the user to have the device act primarily as a watch until a phone call is sent or received. A need also exists for a wrist-worn phone that is more flexible and easier to use. For example, it would be advantageous for a user to utilize a wrist-worn phone which is operable not only when attached to the user's wrist, but is also when separately removed from the user's wristband. Further, it would be advantageous if the functionality and battery life of a wrist-worn unit could be enhanced and extended when attached to a separate phone carriage. Moreover, it would be advantageous to fashion a wrist-worn phone as a watch with standard analog movement. Additionally, it would be advantageous to configure the speaker and microphone elements of a wrist-worn phone to be either water-resistant or waterproof. Finally, it would be beneficial if the problems associated with antenna placement and battery life inherent in the adaptation of cell phone technology to wrist-worn devices could be ameliorated.

### SUMMARY OF THE INVENTION

The present invention overcomes many of the disadvantages of prior art wrist-worn phone devices. The present invention includes a wristphone, comprised of a phone module and an interlocking watch module, that can be inserted into a supporting watchband style receiver, or removed and configured to be inserted into a conventional cell phone style carriage. Both the wristphone and the cell phone style carriage can include discrete speaker and microphone components, allowing smaller components to be used in the wristphone configuration. Other features and functionalities may also be separated from the core phone module such as a numeric keypad with varying styling options, a supplementary battery, an improved antennae, an IrDA interface, Bluetooth radio, MP3 player, or digital camera.

In accordance with another feature of the invention, the phone module and the watch module have complementary surfaces that allows the two to snap together. Likewise, the assembled wristphone can be snapped into a receiver unit on a wristband, such that either the watch or the phone module can be visible to the user. When a call arrives, the wristphone can be removed from the receiver unit and the call answered. When the call is complete, the wristphone can be re-coupled to the receiver unit. Alternatively, the wristphone can also be operated while still attached to the receiver unit on the wristband. This provides the user with a simple way to have both a watch and a phone without the need for two separate components. Thus, when the user is exercising or needs both hands free, he can still stay in touch with his phone.

In accordance with another feature of the invention, the phone module of the wristphone may also be configured with a carriage unit. The carriage unit has a surface complementary to that of the phone module such that in this configuration, the phone module and carriage unit may be snapped together to form a conventionally styled cell phone. The carriage unit may also comprise components which expand the battery life and the functionality of the phone module.

In accordance with still another feature of the invention, the entire wristphone may also be configured with an alternate carriage unit. The alternate carriage unit includes means for grasping and coupling the entire wristphone so as to form in combination an alternate embodiment of a conventionally styled cell phone. The carriage unit may also comprise components which extend the battery life and the functionality of the wristphone.

### BRIEF DESCRIPTION OF THE DRAWINGS

A more complete understanding of the method and apparatus of the present invention may be had by reference to the following detailed description when taken in conjunction with the accompanying drawings, wherein:

FIGS. 1a, 1b, 1c, 1d, 1e, 1f, 1g and 1h are assorted views of a prior art phone technology;

FIG. 1i, is a block diagram of the essential components to a conventional GSM digital mobile phone;

FIG. 2a is a perspective in exploded view of the phone module and watch module in an embodiment of the wristphone of the present invention;

FIG. 2b is a perspective in engaged view of the phone module and watch module in an embodiment of the wristphone of the present invention;

FIG. 2c is an exploded schematic cross sectional side view of an embodiment of the wristphone of the present invention;

FIG. 2d is an engaged schematic cross sectional side view of an embodiment of the wristphone of the present invention;

FIG. 2e is an schematic cross sectional view of the top side of the phone module of the wristphone of the present invention;

FIG. 2f is an exploded perspective view of an embodiment of the watch module of the present invention;

FIG. 3a is a top view of an embodiment of the phone module engaged in the wristphone of the present invention;

FIG. 3b is a side view of an embodiment of the phone module of the present invention illustrating a toggle control that can be used to manipulate the phone module functions;

FIG. 3c is a top view of an alternate embodiment of the phone module of the present invention;

FIGS. 4a, 4b and 4c are perspective views of assorted embodiments of the wrist receiver unit of the present invention;

FIG. 5a is a perspective in exploded view of an embodiment of the present invention illustrating how the wristphone engages a wrist receiver unit;

FIG. 5b is a perspective view of an embodiment of the present invention illustrating the wristphone engaged in the wrist receiver unit and configured with the watch module facing up;

FIG. 5c is a perspective view of an embodiment of the present invention illustrating the wristphone engaged in the wrist receiver unit and configured with the phone module facing up;

FIG. 5d is a side view of an embodiment of the present invention illustrating the wristphone engaged in the wrist receiver unit and configured with the phone module facing up;

FIG. 5e is a side view of another embodiment of the present invention illustrating the alternate embodiment of the wristphone engaged in the wrist receiver unit and configured with the watch module facing up;

FIG. 6a is a perspective in exploded view of an embodiment of the phone module of the present invention illustrating how the phone module engages a carriage unit;

FIG. 6b is a perspective view of an embodiment of the phone module of the present invention illustrating the phone module engaged in the carriage unit,

FIG. 7a is a frontal exploded view of an alternate embodiment of the wristphone of the present invention illustrating how the wristphone engages an alternate carriage unit;

FIG. 7b is a frontal view of an alternate embodiment of the wristphone of the present invention illustrating a first view of the wristphone engaged in the alternate carriage unit; and

FIG. 7c is a frontal view of an alternate embodiment of the wristphone of the present invention illustrating a reverse or second view of the wristphone engaged in the alternate carriage unit.

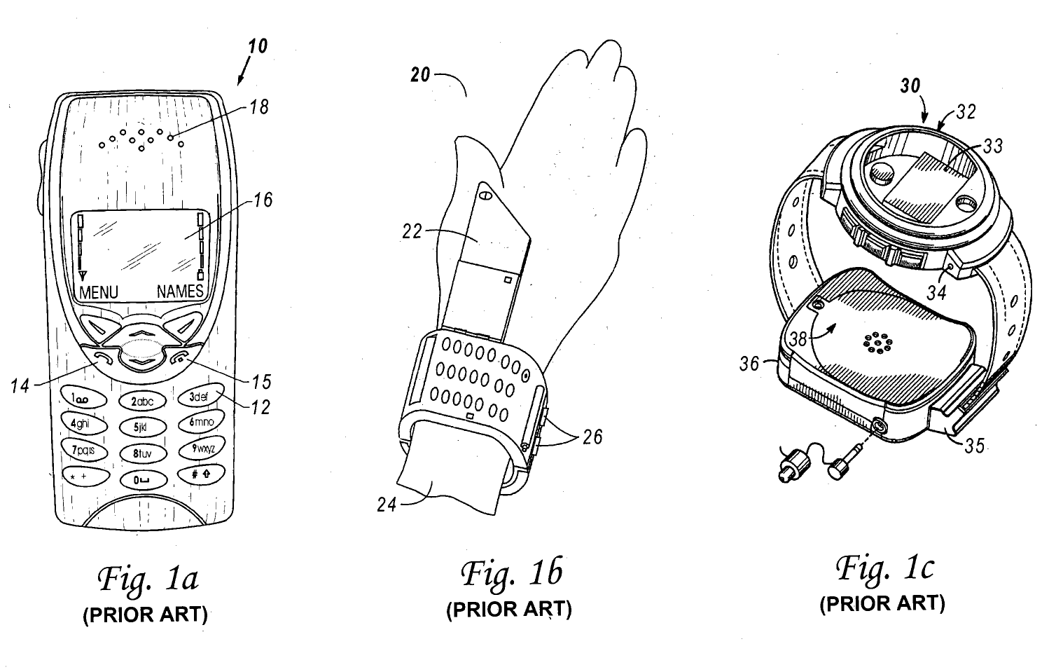

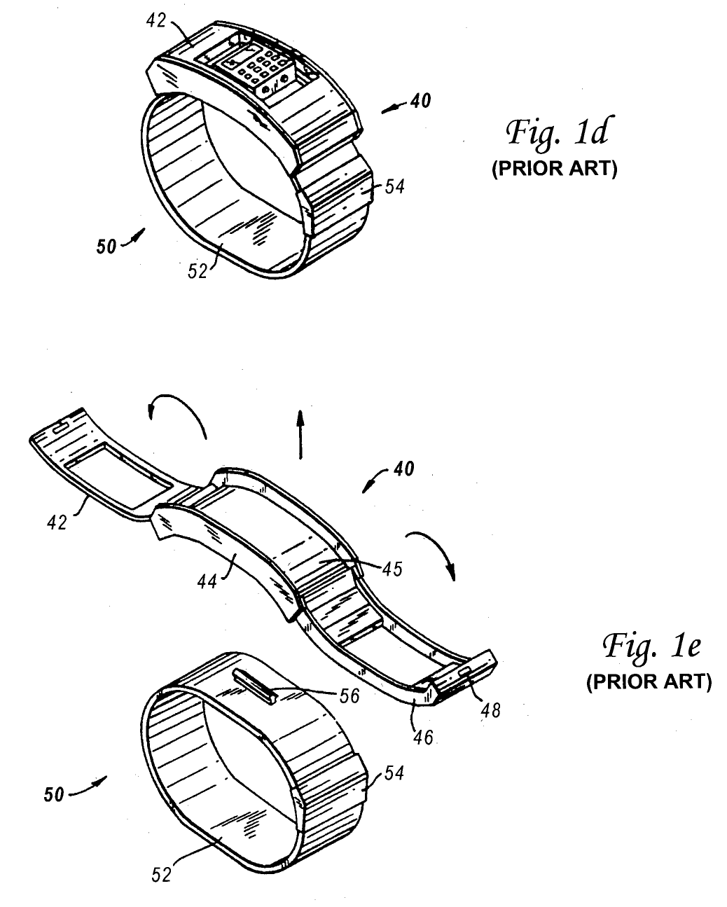

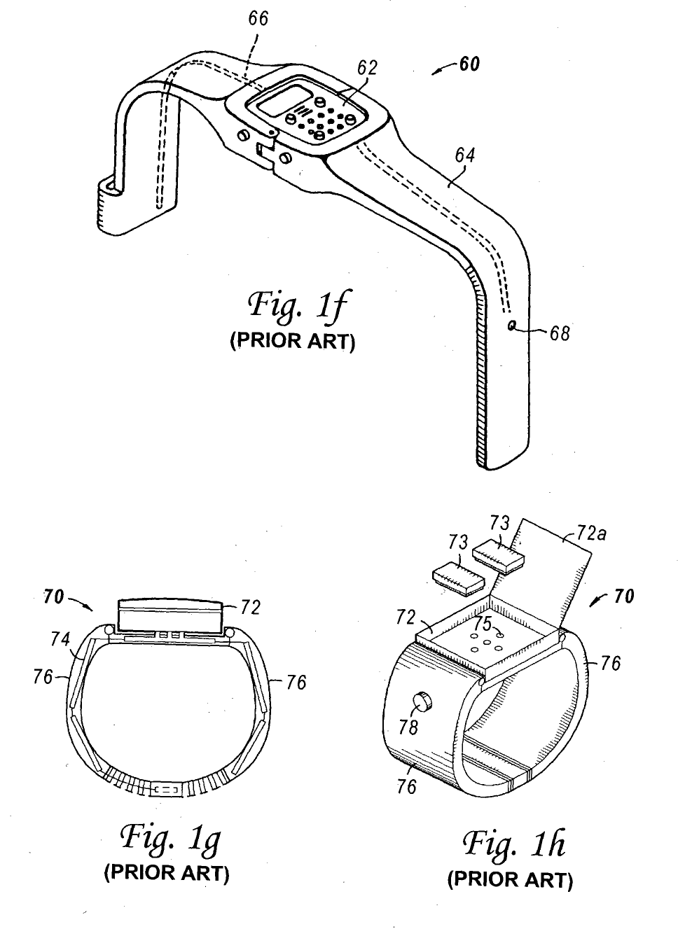

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

### DETAILED DESCRIPTION OF THE INVENTION

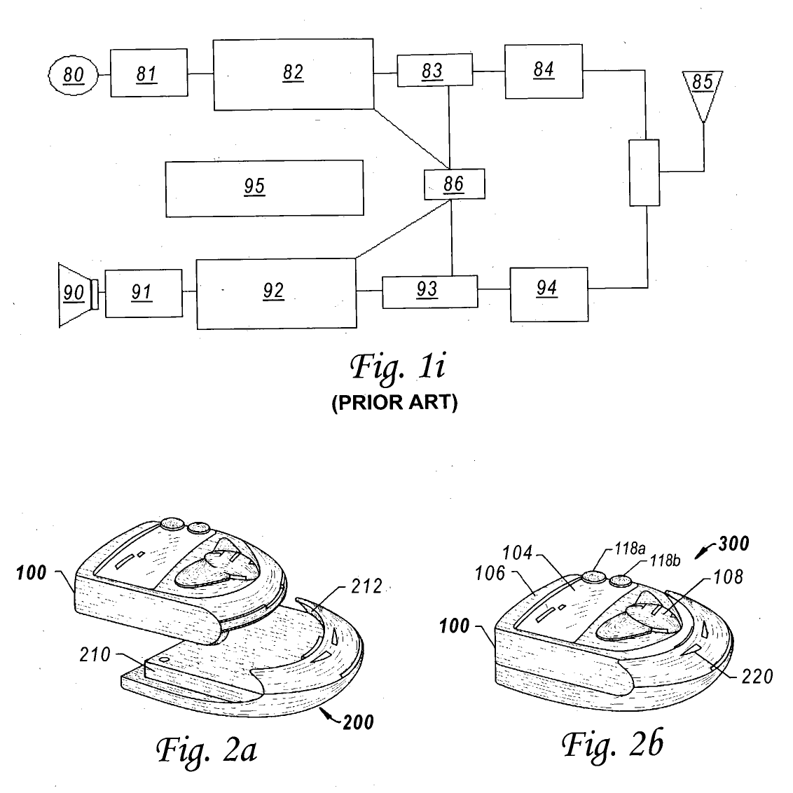

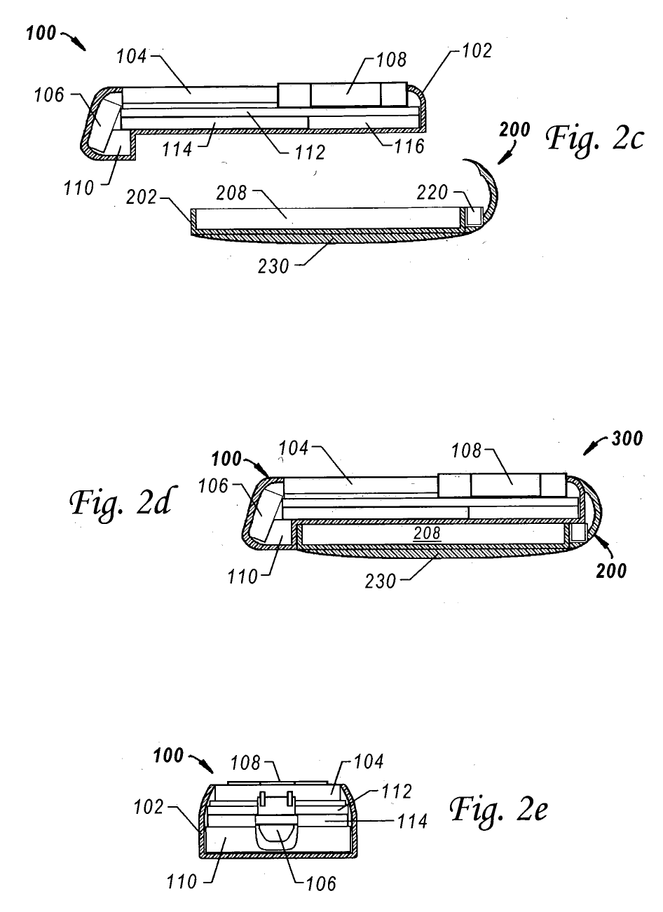

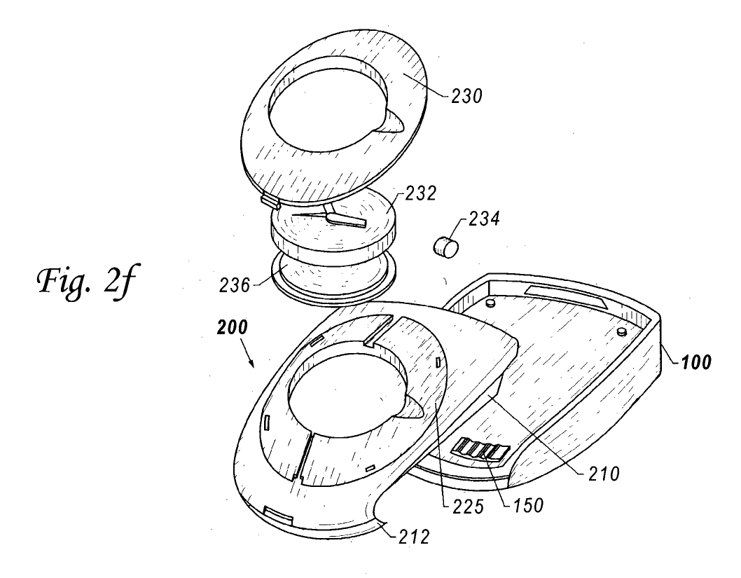

Referring now to FIGS. 2a and 2b, a perspective view of an embodiment of the wristphone 300 of the present invention is shown. The wristphone 300 is comprised of a phone module 100 and an interlocking watch module 200. The phone module 100 includes a display 104, a ringer to announce an incoming call (not shown), a speaker 106 and controls 108 to answer and end a call. As shown in the cross-sectional views depicted in FIGS. 2c, 2d, and 2e, the phone module 100 may also include within its housing 102 an internal antenna 110, a printed circuit board card (PCB) 112, a module 114, and a SIM connector 116. The internal antenna 110 is positioned a sufficient distance away from any circuitry underneath the antenna 110 to preclude interference. The housing above the RF portion of the PCB 112 is shielded and grounded. Additionally, the receiver circuit has a metal enclosure. The phone module 100 provides very basic functionality for the user. For example, in the embodiment shown, the phone module 100 does not have a keypad for alphanumeric entry. However, the phone module 100 may include a memory for storing phone numbers. In the embodiment shown to FIG. 2b, two separate buttons 118a, 118b are provided for scrolling through names in a memory list.

The watch module 200 comprises a housing 202 which includes complementary surfaces 210, 212 that conforms to and couple with a matching surface on the phone module 100. The watch module 200 further includes within its housing 202 an enclosed battery 208, a clock, and a microphone 220. The battery 208 may be comprised of a conventional lithium-ion cell or a custom formed lithium polymer cell. When the phone module 100 and watch module 200 are snapped together, they collectively form a wristphone 300. When the phone module 100 and watch module 200 are properly conjoined, the battery 208 connects with the phone module 100 to power the phone module 100.

FIG. 2f provides an exploded perspective view of an embodiment of the watch module 200 of the present invention. In the embodiment shown, the module 200 includes a removable face cover 230 that snaps onto the module 200. The face cover 230 has a transparent portion that allows the user to see the display of a clock component 232. The display of clock component 232 can be an analog dial as shown or a digital display. An auxiliary battery 236 may be placed under the clock component 232 to provide power. A winder 234 may also be used to adjust the time or date displayed on the display of clock component 232.

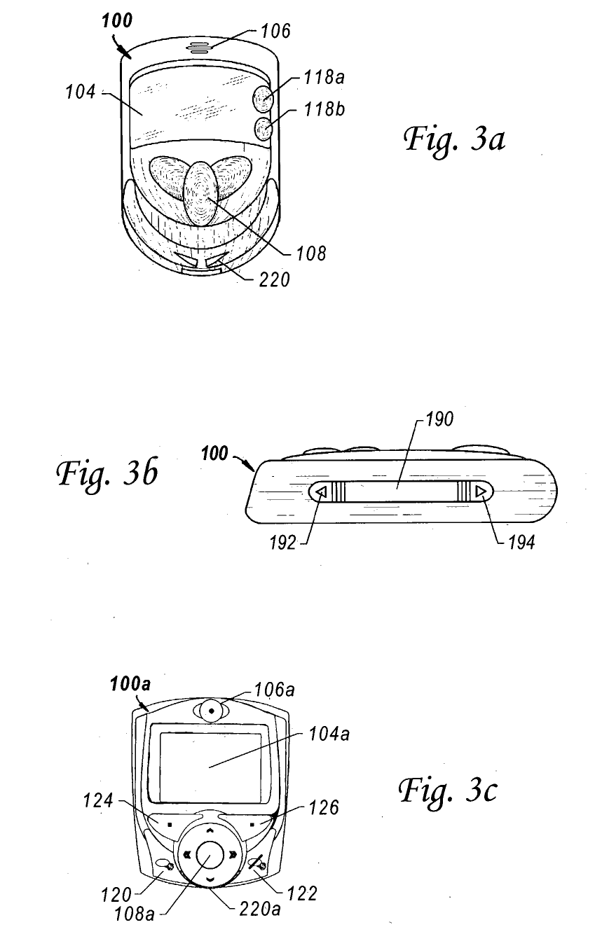

Referring now to FIG. 3a, which illustrates a top view of the face of an embodiment of the phone module 100 engaged in the wristphone 300 of the present invention, while the embodiment illustrated includes two separate buttons 118a, 118b for scrolling through names in a memory list, FIG. 3b shows an alternate embodiment wherein a rocker switch 190 is used. The rocker switch 190 can be located on the side of the phone module 100. A user can scroll through a list using controls 192, 194.

FIG. 3c shows a top view of the face of an alternate embodiment of the phone module 100a engaged in the wristphone 300 of the present invention. While the originally illustrated embodiment of phone module 100 provides only basic functionality to the user, the alternate embodiment of the phone module 100a illustrated in FIG. 3c, may provide the full functionality of a conventional keypad using a novel methodology in the modes, functionality, and sequencing of its controls buttons. Phone module 100a includes a display 104a, a multi-positioned toggle switch 108a, an enter/call button 120, a end/exit button 122, a menu selection button 124, and a directory button 126.

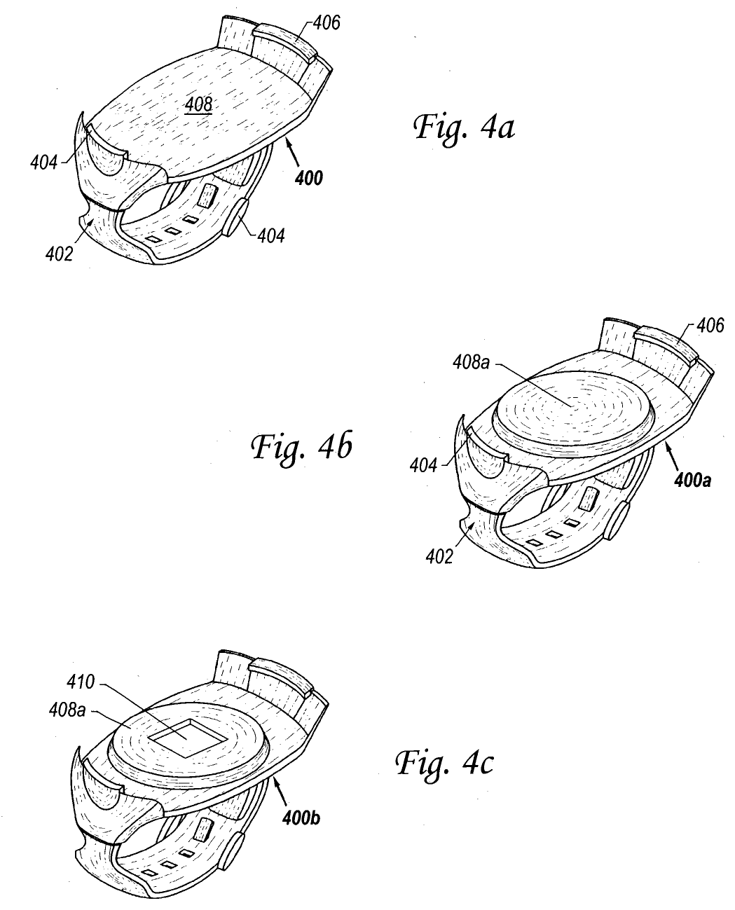

With reference now to FIG. 4a, an embodiment of the wrist receiver unit 400 of the present invention is shown which is incorporated onto a conventional watchband 402. The conventional watchband 402 may further comprise a mechanism or device for attaching and adjusting 404 (e.g., a prong buckle) to a user's wrist. The wrist receiver unit 400 includes a base 408 and two opposing biased clips 404, 406 which securely grasp the wristphone 300. The portions of the wrist receiver unit 400 surrounding clips 404, 406 are provided with surfaces complementary to the matching surfaces on the wristphone 300 to ensure a tight and snug fit. The clips 404, 406 may also include portions which project into recesses in the wristphone 300.

FIGS. 4b and 4c illustrate alternate embodiments of the wrist receiver unit 400a, 400b which may further include a convexity 408a and/or concavity 410 to protect and/or interlock with one or both sides of the wristphone 300. In particular, convexity 408a and/or concavity 410 may also include sealing means for certain components of the wristphone 300 (e.g., case opening for microphone and speaker) thereby improving the water resistance of the components. The sealing means may include gaskets adapted to the wrist receiver unit 400a or manufacturing all or part of the wrist receiver unit 400a using flexible materials capable of conforming its shape to that of the wristphone so as to provide a water resistant or waterproof seal.

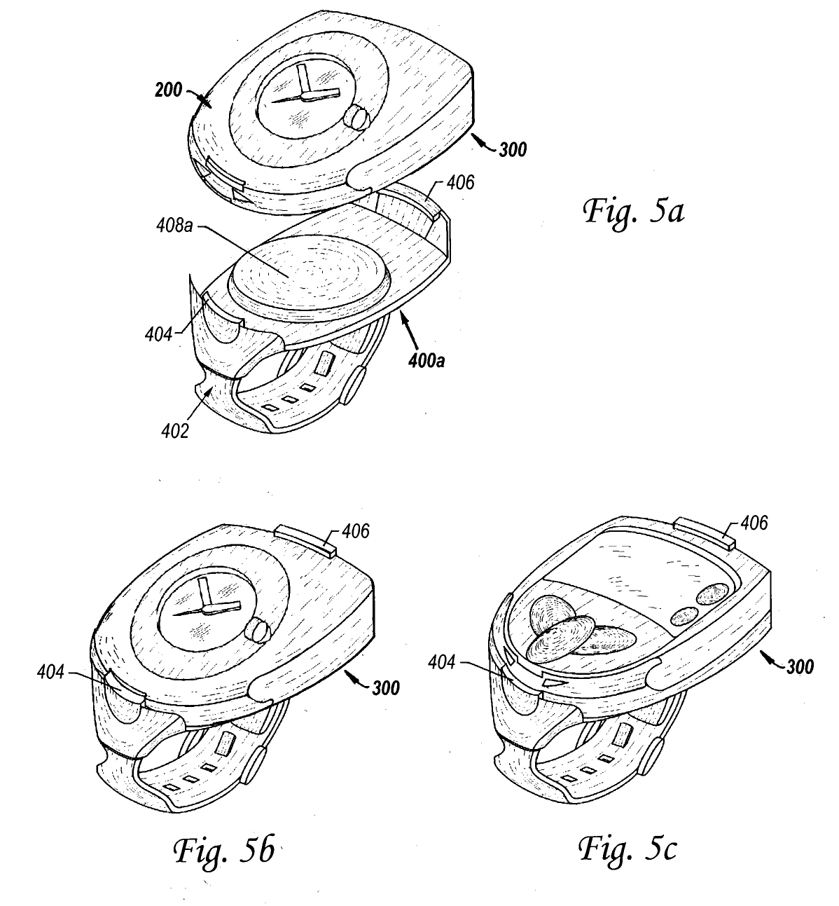

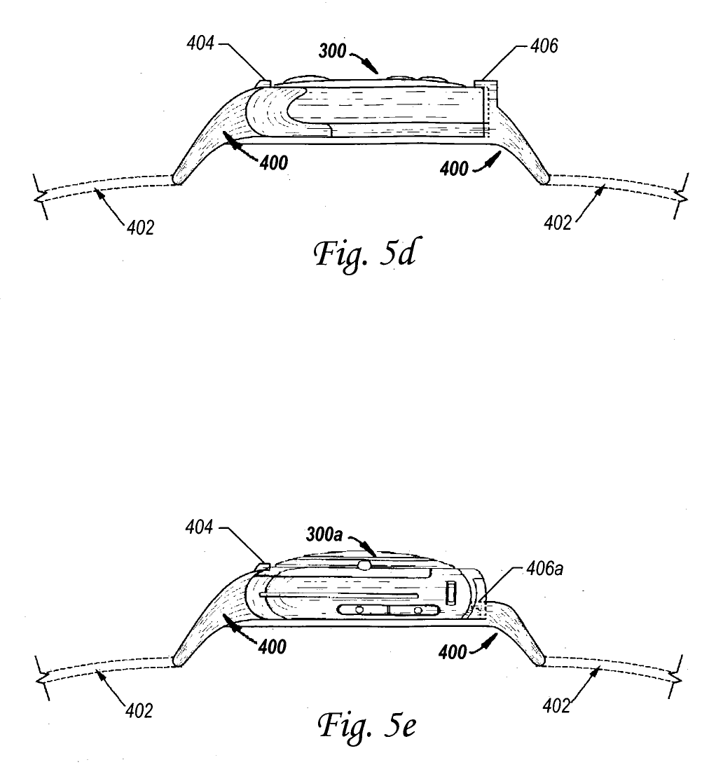

Referring now to FIGS. 5a, 5b, and 5c, perspective views of an embodiment of the present invention are shown illustrating how the wristphone 300 engages a wrist receiver unit 400a. As shown in FIG. 5b, the wristphone 300 may be configured in the wrist receiver unit 400a with the watch module 200 facing up. Alternatively, the wristphone 300 may be configured in the wrist receiver unit 400a with the digital display of the phone module 100 facing up, as shown in FIG. 5c. In either configuration, clips 404, 406 securely grasp the wristphone 300 as illustrated in FIG. 5d. Moreover, as shown in the alternate embodiment of the present invention illustrated in FIG. 5e, clips 404, 406a may also include portions which project into and securely engage recesses in the wristphone 300a.

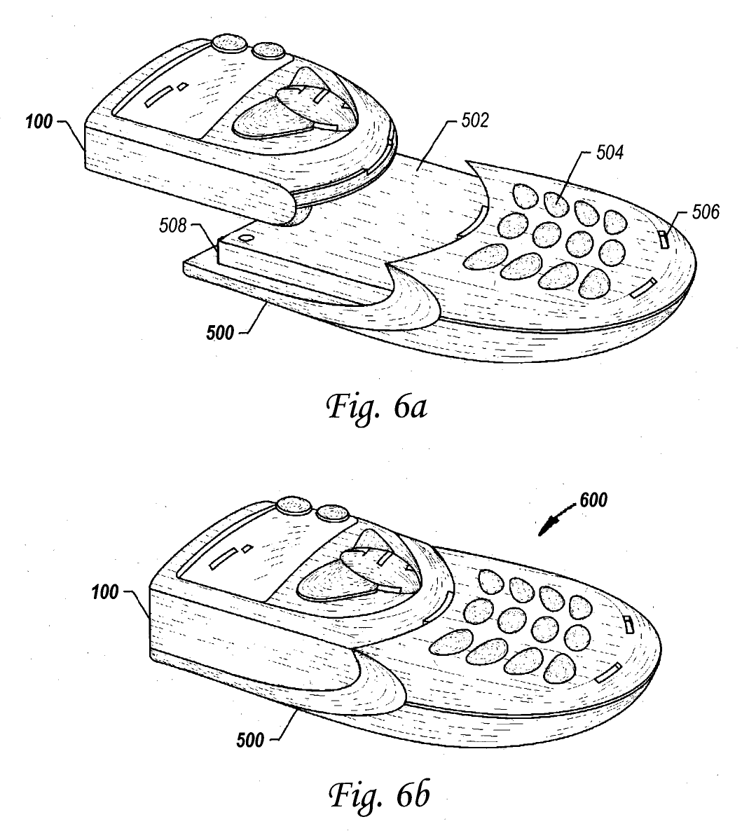

The wristphone 300 may also be coupled to a more traditional phone carriage unit thereby enhancing the utility and flexibility of the present invention. For example, in one embodiment of the present invention, the phone module 100 may be coupled to a more traditional phone carriage unit 500 as shown in FIGS. 6a and 6b. The phone module 100 has a surface that complements the carriage surface 502 allowing them to be securely coupled to form in combination a cell phone 600. The carriage unit 500 may provide additional functionality, such as a full keypad 504, enhanced speaker 508, IrDA interface (not shown), digital camera (not shown), MP3 player (not shown), charging/power jack (not shown), and a data communication port (not shown). The carriage unit 500 can also provide for an improved microphone 506 and headphone jack (not shown). Moreover, due to its size, the carriage unit 500 can hold a separate and/or additional longer-lasting battery. As with the battery 208 in the watch module 200, the battery contained in the carriage unit 500 may also be a conventional lithium-ion cell or a custom formed lithium polymer cell. The carriage unit 500 can also act as the primary means whereby the battery 208 in the watch module 200 may be recharged. Additionally, charging/power jack may be used in a conventional manner to provide power directly to cell phone 600 either while recharging the battery contained within the carriage unit 500 or battery 208 or in the absence of any installed batteries.

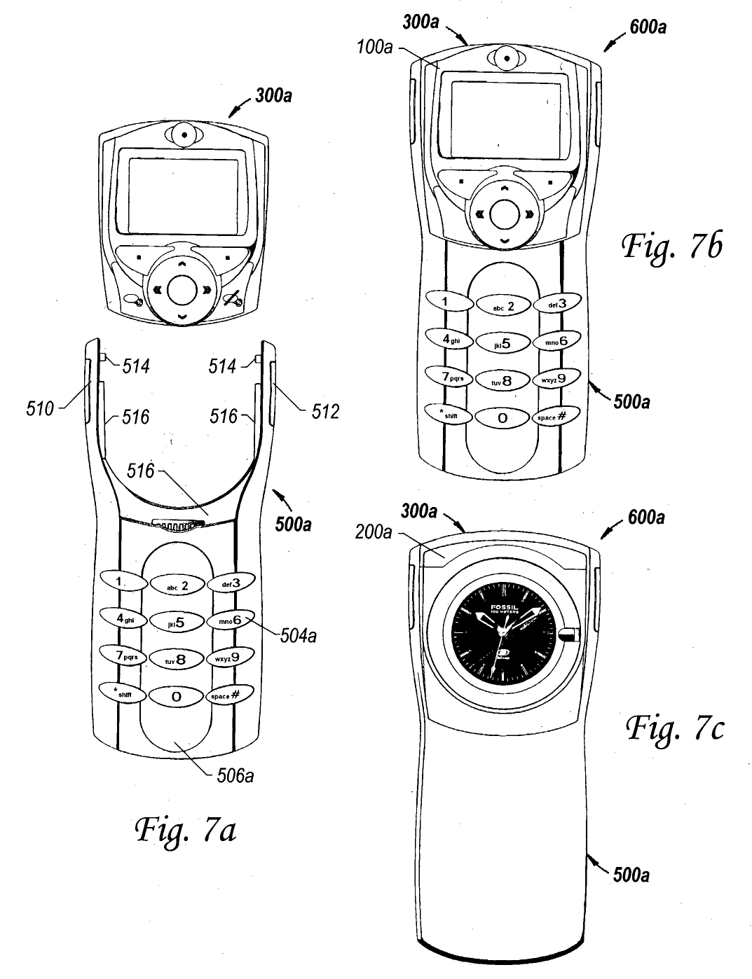

Alternatively, in a preferred embodiment of the present invention, the entire wristphone 300a may be coupled to an alternate phone carriage unit 500a as shown in FIGS. 7a, 7b and 7c. In addition to the added functionality of the first embodiment of the carriage unit 500, the alternate phone carriage unit 500a also includes means for coupling the entire wristphone 300a so as to form in combination an alternate embodiment of the cell phone 600a. As illustrated in FIG. 7a, in one embodiment the means for coupling may include opposing prongs 510, 512 for securely grasping the sides of the wristphone 300a. The means for coupling may further include guiding surfaces 516 to properly align the wristphone 300a between the opposing prongs 510, 512, and locking pins 514 to securely couple the wristphone 300a and the alternate phone carriage unit 500a. Whereas the first embodiment of the cell phone 600 displays only the face of the phone module 100 (see FIG. 6b), the alternate and preferred embodiment of the cell phone 600a is capable of simultaneously displaying both the face of the phone module 100a in one view (see FIG. 7b) and the face of the watch module 200a (see FIG. 7c) in another view. Moreover, the preferred embodiment of the cell phone 600a is also capable of using the integral battery of wristphone 300a as a source of power.

Thus, the device of the present invention may be employed in two basic modes: a wrist-worn mode and a conventional cell phone mode. As shown in FIGS. 5b and 5c, in the wrist-worn mode, the wristphone 300 is engaged in a wrist receiver unit 400 and configured with either the watch module 200 or the phone module 100 facing up. When a call arrives, the user may be alerted with either a tone or a light. In one embodiment, the tone may be a traditional ringing sound, and the light may be a flashing LED or LCD or bioluminescent. In another embodiment, the wristphone 300 may have a vibrator that alerts the user to an incoming call. The user may answer the call pushing the appropriate button on the phone module 100 and then either leaving the wristphone 300 in the wrist receiver unit 400 or detaching the wristphone 300 from the clips 404, 406 in the wrist receiver unit 400. In one embodiment, the act of detaching the wristphone 300 from wrist receiver unit 400 may initiate the answering of the call. If equipped with a caller ID functionality, the identity of the caller may be shown on the display 104. When the call is complete, the user can simply press the appropriate button to end the call. If previously removed, the wristphone 300 can then be placed back in to the wrist receiver unit 400 so that either the phone module 100 or the watch module 200 is visible.

Alternatively, to send a call, a user can scroll through a preloaded list of telephone numbers stored in memory, selecting the appropriate number by depressing controls 108 to initiate the call. Selecting and initiating a call can be accomplished with the wristphone 300 either engaged in or disengaged from the wrist receiver unit 400. Indeed, all of the steps in placing or receiving a call can be accomplished while the wristphone 300 is latched into the wrist receiver unit 400. The user may simply find it more convenient to remove the wristphone 300.

The cell phone mode is accomplished in one of two configurations detailed previously. Thus, either a phone module 100 is engaged in a carriage unit 500, as shown in FIGS. 6a and 6b, or the entire wristphone 300a is configured in an alternate carriage unit 500a, as shown in FIGS. 7a, 7b, and 7c. In either configuration, the functionalities of the wristphone or phone module and its associated carriage unit supplement and complement each other such that the resulting cell phone operates in a manner similar to conventional cell phones. Thus, when a call arrives, the user may be alerted with either a tone or a light. In one embodiment, the tone may be a traditional ringing sound, and the light may be a flashing LED or LCD or bioluminescent. In another embodiment, the cell phone may have a vibrator that alerts the user to an incoming call. The user may answer the call by pushing the appropriate button on the phone module. If equipped with a caller ID functionality, the identity of the caller may be shown on the display. When the call is complete, the user can simply press the appropriate button on the phone module to end the call. To send a call, a user can may use the buttons on full keypad 504 or scroll through a preloaded list of telephone numbers stored in memory in a conventional manner using control buttons on the phone module, selecting the appropriate number by depressing the appropriate control button to initiate the call. Additionally, phone numbers and other data may be entered in the memory of the phone module by means of the keypad 504, IrDA interface, or the data communication port.

It will now be evident to those skilled in the art that there has been described herein an improved wearable phone and wristwatch device. Although the invention hereof has been described by way of a preferred embodiment, it will be evident that other adaptations and modifications can be employed without departing from the spirit and scope thereof. For example, the present invention envisions alternate embodiments which may use either GSM or CDMA technology. While the two technologies differ significantly from one another and are incompatible with one another, it is understood that from a conceptual point of view the handsets components of the two technologies are very similar. While the embodiments depicted in many of the various Figures illustrate a GSM version of the present invention, it is understood that either CDMA or GSM technology, or for that matter any suitable cell phone technology format. Thus, the terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A wrist-worn phone comprising:
(a) a wristphone comprising in interlocking combination a phone module having a first set of functionality and a watch module, wherein said watch module includes a clock and a first battery for powering said phone module, and
(b) a wristband having a receiver unit with grasping means to selectably hold said wristphone in more than one configuration,
wherein said wristphone is operable both when attached to and detached from said receiver unit.

2. The wrist-worn phone of claim 1 wherein the first set of functionality includes a first speaker.

3. The wrist-worn phone of claim 1 wherein the first set of functionality includes a first microphone.

4. The wrist-worn phone of claim 3 wherein the first set of functionality includes a software system to enhance recognition of voice by said first microphone.

5. The wrist-worn phone of claim 1 wherein the first set of functionality includes a call answer button.

6. The wrist-worn phone of claim 1 wherein the first set of functionality includes a call end button.

7. The wrist-worn phone of claim 1 wherein the first set of functionality includes a memory for storing a database.

8. The wrist-worn phone of claim 7 wherein said database includes a plurality of files.

9. The wrist-worn phone of claim 8 wherein each of said plurality of files comprises a name and a telephone number.

10. The wrist-worn phone of claim 8 wherein the first set of functionality includes means for scrolling through said plurality of files.

11. The wrist-worn phone of claim 1 wherein the watch module further includes a second microphone selectively and operatively connected to said phone module.

12. The wrist-worn phone of claim 1 wherein the clock includes an analog display.

13. The wrist-worn phone of claim 1 wherein the clock includes a digital display.

14. The wrist-worn phone of claim 1 wherein watch module further includes an auxiliary battery for powering said clock.

15. The wrist-worn phone of claim 1 wherein said grasping means comprises two opposing biased clips.

16. The wrist-worn phone of claim 15 wherein said grasping means further comprises a base disposed between said clips.

17. The wrist-worn phone of claim 16 wherein said base includes a convexity.

18. The wrist-worn phone of claim 17 wherein said convexity includes sealing means for imparting water resistant seal between the receiver unit and the wristphone.

19. The wrist-worn phone of claim 16 wherein said base includes a concavity.

20. The wrist-worn phone of claim 19 wherein said convexity includes sealing means for imparting water resistant seal between the receiver unit and the wristphone.

21. The wrist-worn phone of claim 1 wherein a first configuration comprises displaying a face of said phone module.

22. The wrist-worn phone of claim 1 wherein a second configuration comprises displaying a face of said watch module.

23. The wrist-worn phone of claim 1 further comprising a phone carriage having a second set of functionality and means for selectably interlocking with said phone module, wherein said second set of functionality is operably connected to said phone module when interlocked with said phone module.

24. The wrist-worn phone of claim 23 wherein the second set of functionality comprises an alphanumeric keypad.

25. The wrist-worn phone of claim 23 wherein the second set of functionality comprises a second battery.

26. The wrist-worn phone of claim 23 wherein the second set of functionality comprises a second microphone selectively operable with said phone module.

27. The wrist-worn phone of claim 23 wherein the second set of functionality comprises a second speaker selectively operable with said phone module.

28. The wrist-worn phone of claim 23 wherein the second set of functionality comprises an IrDA interface.

29. The wrist-worn phone of claim 23 wherein the second set of functionality comprises a digital camera.

30. The wrist-worn phone of claim 23 wherein the second set of functionality comprises a MP3 player.

31. The wrist-worn phone of claim 23 wherein the second set of functionality comprises a Bluetooth radio.

32. The wrist-worn phone of claim 23 wherein the second set of functionality comprises a charging jack.

33. The wrist-worn phone of claim 32 wherein said charging jack is operable to charge said first and second battery.

34. The wrist-worn phone of claim 23 wherein the second set of functionality comprises a data communication port.

35. The wrist-worn phone of claim 23 wherein the first set of functionality includes a memory for storing a database and the second set of functionality includes means for importing data into said memory.

36. The wrist-worn phone of claim 1 further comprising a phone carriage having a second set of functionality and means for selectably interlocking with said wristphone, wherein said second set of functionality is operably connected to said phone module when interlocked with said wristphone.

37. The wrist-worn phone of claim 36 wherein the second set of functionality comprises an alphanumeric keypad.

38. The wrist-worn phone of claim 36 wherein the second set of functionality comprises a second battery.

39. The wrist-worn phone of claim 36 wherein the second set of functionality comprises a second microphone selectively operable with said phone module.

40. The wrist-worn phone of claim 36 wherein the second set of functionality comprises a second speaker selectively operable with said phone module.

41. The wrist-worn phone of claim 36 wherein the second set of functionality comprises an IrDA interface.

42. The wrist-worn phone of claim 36 wherein the second set of functionality comprises a digital camera.

43. The wrist-worn phone of claim 36 wherein the second set of functionality comprises a MP3 player.

44. The wrist-worn phone of claim 36 wherein the second set of functionality comprises a Bluetooth radio.

45. The wrist-worn phone of claim 36 wherein the second set of functionality comprises a charging jack.

46. The wrist-worn phone of claim 36 wherein said charging jack is operable to charge said first and second battery.

47. The wrist-worn phone of claim 36 wherein the second set of functionality comprises a data communication port.

48. The wrist-worn phone of claim 36 wherein the first set of functionality includes a memory for storing a database and the second set of functionality includes means for importing data into said memory.

49. A communication apparatus capable of receiving and transmitting wireless communications, comprising:
(a) a phone module having a display and a first set of functionality and operable in more than one configuration;
(b) a second module comprising a first battery and including means for selectably interlocking with said phone module in a first configuration;
(c) a carriage unit having a second set of functionality and means for selectably interlocking with said phone module in a second configuration, wherein said second set of functionality is operably connected to said phone module when interlocked with said phone module; and
(d) a wristband having a receiver unit with grasping means to selectably hold said interlocked phone and second module in said first configuration, wherein said receiver unit can hold said interlocked modules in more than one orientation.

50. The communication apparatus of claim 49 wherein the second module further comprises a clock element.

51. A communication apparatus, comprising:
(a) a wristphone capable of receiving and transmitting wireless communications, comprising:
(1) a phone module having a display and a first set of functionality,
(2) an integral battery, and
(3) a watch module;
(b) a wristband having a receiver unit with grasping means to selectably hold said wristphone in more than one orientation; and
(c) a carriage unit having a second set of functionality and means for selectably interlocking with said wristphone, wherein said second set of functionality is operably connected to said phone module when interlocked with said wristphone.

52. A phone carriage, comprising a first set of functionality and having means for selectably interlocking with a phone module in a first configuration, wherein said phone module has a second set of functionality and is operable in more than one configuration, and wherein said first set of functionality is operably connected to said phone module when interlocked in said first configuration.

53. The phone carriage of claim 52 wherein the first set of functionality comprises an alphanumeric keypad.

54. The phone carriage of claim 52 wherein the first set of functionality comprises a battery.

55. The phone carriage of claim 52 wherein the first set of functionality comprises a microphone selectively operable with said phone module.

56. The phone carriage of claim 52 wherein the first set of functionality comprises a first speaker selectively operable with said phone module.

57. The phone carriage of claim 52 wherein the first set of functionality comprises an IrDA interface.

58. The phone carriage of claim 52 wherein the first set of functionality comprises a digital camera.

59. The phone carriage of claim 52 wherein the first set of functionality comprises a MP3 player.

60. The phone carriage of claim 52 wherein the first set of functionality comprises a Bluetooth radio.

61. The phone carriage of claim 52 wherein the first set of functionality comprises a charging jack.

62. The phone carriage of claim 52 wherein said charging jack is operable to charge said battery.

63. The phone carriage of claim 52 wherein the first set of functionality comprises a data communication port.

64. The phone carriage of claim 52 wherein said first set of functionality can import data into said memory.

65. The phone carriage of claim 52 wherein the first set of functionality comprises a alphanumeric keypad.

66. The phone carriage of claim 52 wherein the first set of functionality comprises an IrDA interface.

67. The phone carriage of claim 52 wherein the first set of functionality comprises a digital camera.

68. The phone carriage of claim 52 wherein the first set of functionality comprises a MP3 player.

69. The phone carriage of claim 52 wherein the first set of functionality comprises a data communication port.

70. A phone carriage, comprising a first set of functionality and having means for selectably interlocking with a wristphone in a first configuration, said wristphone being operable in more than one configuration and comprising in interlocking combination a phone module and a watch module, wherein said phone module includes a second set of functionality, and wherein said first set of functionality is operably connected to said phone module when interlocked in said first configuration.

71. A wristband operable for holding a wristphone, comprising a receiver unit with grasping means to selectably hold said wristphone in more than one orientation.

72. The wristband of claim 71 wherein said grasping means comprises two opposing biased clips.

73. The wristband of claim 71 wherein said biased clips grasp the outer periphery of said wristphone.

74. The wristband of claim 71 wherein said biased clips project into and securely engage recesses in said wristphone.

75. The wristband of claim 71 wherein said grasping means further comprises a base disposed between said clips.
